(19) United States
(12) Patent Application Publication
(10) Pub. No.: US 2011/0080424 A1
(43) Pub. Date: Apr. 7, 2011

(54) IMAGE PROCESSING

(75) Inventors: Marc Andre Peters, Eindhoven (NL); Tsvetomira Tsoneva, Eindhoven (NL); Pedro Fonseca, Eindhoven (NL)

(73) Assignee: KONINKLIJKE PHILIPS ELECTRONICS N.V., EINDHOVEN (NL)

(21) Appl. No.: 12/999,381

(22) PCT Filed: Jun. 17, 2009
(86) PCT No.: PCT/IB09/52576

§ 371 Date: Dec. 16, 2010

(30) Foreign Application Priority Data
Jun. 24, 2008 (EP) 08158825.3

(51) Int. Cl. G06K 9/32; G09G 5/00

(52) U.S. Cl. 345/620; 382/294

(57) ABSTRACT

A method of processing a plurality of images comprises receiving a plurality of images, defining a set of images for processing, from the plurality of images, aligning one or more components within the set of images, transforming one or more of the aligned images by cropping, resizing and/or rotating the image(s) to create a series of transformed images, and creating an output comprising the series of transformed images, the output comprising either a stop motion video sequence or a single image.

### FIELD OF THE INVENTION

This invention relates to a method of, and a system for, processing a plurality of images.

### BACKGROUND OF THE INVENTION

Taking photographs with digital cameras is becoming increasingly popular. One of the advantages of using such a digital camera is that a plurality of images may be captured, stored, and manipulated, by using the digital camera and/or a computer. Once a group of images has been captured and stored, the user who has access to the images needs to decide how to use the digital images. There are different digital image handling programs, for example, available to users. For example, the user may edit all or part of a digital image with a photo editing application, may transfer a digital image file to a remote resource on the Internet in order to share the image with friends and family, and/or may print one or more images in the traditional manner. While such digital image handling tasks are usually carried out using a computer, other devices may also be used. For example, some digital cameras and have such capabilities built in.

In general, people tend to take more and more digital images, and often several images of one specific object, scene, or occasion. By showing them in a slide show, for example in a digital photo frame, it is not always most appealing to have a whole set of similar images being displayed one after the other with regular display times. On the other hand, these images are often connected, in the sense that they relate to the same event or occasion, so selecting only one of the images in the set to display can take away a lot from the experience of the user. The question arises, in this context, as to how to use all of the images without making it a rather boring slideshow.

One example, of a technique for handling digital images is disclosed in U.S. Patent Application Publication 2004/0264939, which relates to content-based dynamic photo-to-video methods. According to this Publication methods, apparatuses and systems are provided that automatically convert one or more digital images (photos) into one or more photo motion clip. The photo motion clip defines simulated video camera or other like movements/motions within the digital image(s). The movement/motions can be used to define a plurality or sequence of selected portions of the image(s). As such, one or more photo motion clips may be used to render a video output. The movement/motions can be based on one or more focus areas identified in the initial digital image. The movement/motions may include panning and zooming, for example.

The output provided by this method is an animation based upon the original photographs. This animation does not provide sufficient processing of the images to provide an output that is always desirable to the end user.

### SUMMARY OF THE INVENTION

It is therefore an object of the invention to improve upon the known art. According to a first aspect of the present invention, there is provided a method of processing a plurality of images comprising receiving a plurality of images, defining a set of images for processing, from the plurality of images, aligning one or more components within the set of images, transforming one or more of the aligned images by cropping, resizing and/or rotating the image(s) to create a series of transformed images, and creating an output comprising the series of transformed images, the output comprising either an image sequence or a single image.

According to a second aspect of the present invention, there is provided a system for processing a plurality of images comprising a receiver arranged to receive a plurality of images, a processor arranged to define a set of images for processing, from the plurality of images, to align one or more components within the set of images, and to transform one or more of the aligned images by cropping, resizing and/or rotating the image(s) to create a series of transformed images, and a display device arranged to display an output comprising the series of transformed images, the output comprising either a an image sequence or a single image.

According to a third aspect of the present invention, there is provided a computer program product on a computer readable medium for processing a plurality of images, the product comprising instructions for receiving a plurality of images, defining a set of images for processing, from the plurality of images, aligning one or more components within the set of images, transforming one or more of the aligned images by cropping, resizing and/or rotating the image(s) to create a series of transformed images, and creating an output comprising the series of transformed images, the output comprising either an image sequence or a single image.

Owing to the invention, it is possible to provide a system that automatically creates attractive ways of displaying similar images by either automatically creating a stop-motion image sequence, or by automatically creating a “story telling image” consisting of several images arranged so as to display a sequence of photos depicting an event. It is a technique that can easily be applied to digital photo frames, enhancing the way a user enjoys watching his photos. By automatically aligning the images to the same reference point, when the images are shown as an image sequence, the look of the video sequence is as if they were shot from a steady camera, even if different view points and zoom were used in the capture of the original images.

These techniques can be used in digital photo frames, where the clustering and alignment of the images can be done on a PC using included software. Moreover these techniques can be used by any software or hardware product having image display capabilities. Furthermore, these techniques can also be used to create similar effects based on frames extracted from (home) video sequences. In this case, instead of processing a group of photographs, a group of frames taken (not necessarily every single frame) from the sequence could be used.

Advantageously, the step of defining a set of images for processing, from the plurality of images, comprises selecting one or more images that are closely related according to metadata associated with the images. The processor that is creating the output can receive a large number of images (for example all of the images currently stored on a mass storage media such as a media card) and make an intelligent selection of these images. For example, metadata associated with the images may relate to the time and/or location of the original image, and the processor can select images that are closely related. This might be images that have been taken at a similar time, defined by a predetermined threshold such as a period of ten seconds. Other metadata components can similarly be computed on an appropriate scale to determine images that are closely related. The metadata can be derived directly from the images themselves, for example by extracting low-level features such as colour, or edges. This can help to cluster the images. Indeed a combination of different types of metadata can be used, meaning that metadata that is stored with an image (usually at capture) plus metadata derived from the image can be used in combination.

Preferably, the step of defining a set of images for processing, from the plurality of images, comprises discarding one or more images that fall below a similarity threshold with respect to a different image in the plurality of images. If two images are too similar, then the ultimate output can be improved by deleting one of the similar images. Similarity can be defined in many different ways, for example with reference to changes in low level features (such as colour information or edge data) between two different images. The processor can work through the plurality of images, when defining the set to use, and remove any images that are too similar. This will prevent an apparent repetition in the images, when the final output is generated to the user.

Ideally, the methodology further comprises, following transformation of the aligned images, detecting one or more low-interest components within the aligned images and cropping the aligned images to remove the detected low-interest component(s). Again, the final output can be improved by further processing of the images. Once the images have been aligned and transformed, they can be further improved by focussing in on the important parts of the images. One way that this can be achieved is by removing static components within the image. It can be assumed that the static components are of less interest, and the images can be adapted to remove these components (by cropping away parts of the respective images), to leave the final images focussed on the moving parts of the images. Other techniques might use face-detection in the images, and assume that other parts of the image can be classified as low-interest.

Advantageously, the step of defining a set of images for processing, from the plurality of images, comprises receiving a user input selecting one or more images. The system can be configured to accept a user input defining those images that are to be processed according to the methodology described above. This allows a user to choose those images that they wish to see output as the image sequence or as the combined single image comprised of the processed images.

### BRIEF DESCRIPTION OF THE DRAWINGS

Embodiments of the present invention will now be described, by way of example only, with reference to the accompanying drawings, in which:

FIG. 1 is a schematic diagram of a system for processing images,

FIG. 2 is a flowchart of a method of processing images,

FIG. 3 is a schematic diagram of a plurality of images being processed,

FIG. 4 is a schematic diagram of a digital photo frame,

FIG. 5 is a flowchart of a second embodiment of the method of processing images, and

FIG. 6 is a schematic diagram of an output of the image processing method of FIG. 5.

### DETAILED DESCRIPTION OF THE EMBODIMENTS

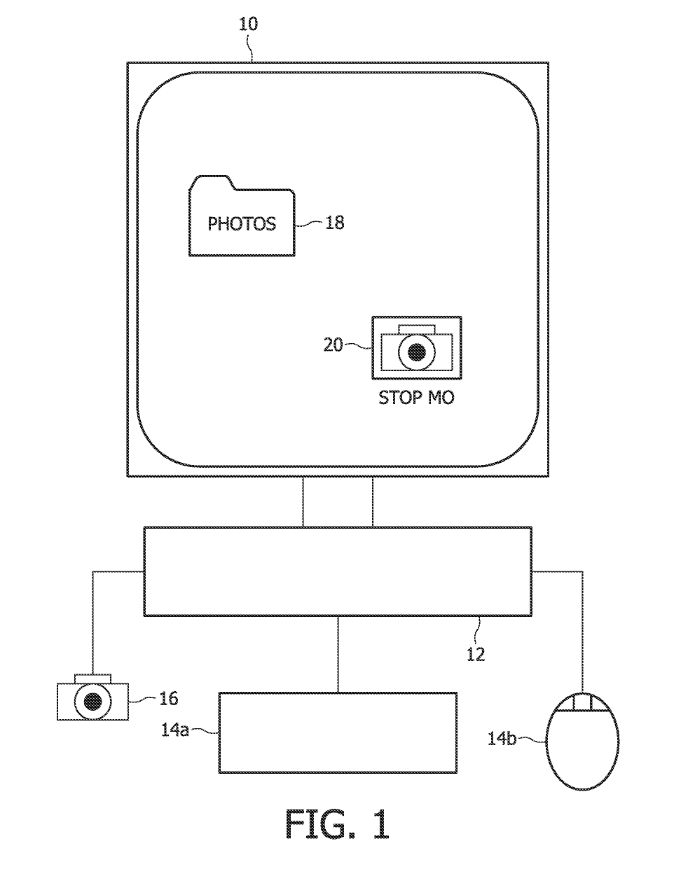

A desktop computing system is shown in FIG. 1, which comprises a display device 10, a processor 12 and user interface devices 14, being a keyboard 14a and a mouse 14b. Additionally, a user has connected a camera 16 to the processor 12, using a conventional connection technology such as USB. The connection of the camera 16 to the processor 12 allows the user to access the images that have been captured by the camera 16. These images are shown as the folder 18, which is a graphical user interface component displayed by the display device 10. The display device 10 is also showing an icon 20, which represents an installed application (called “STOP MO”) that is installed on the processor 12.

The user can use the installed application STOP MO to process their images. For example, the user can simply drag-and-drop the folder 18 onto the icon 20, using well-known user interface techniques, to request that the contents of the folder 18 be processed by the application represented by the icon 20. The images stored in the folder 18, which originate from the camera 16, are then processed by the application. Other methods of instigating the processing methodology are possible. For example, the STOP MO application could be launched by double-clicking the icon 29, in the conventional manner, and then, within this application source images can be found by browsing the computer's storage devices.

The purpose of the application STOP MO is to process the user's images to provide an output that is attractive to the user. In one embodiment, the application can be used to provide a personal stop-motion image sequence, from the source images. The application represented by the icon 20 provides a system that automatically creates attractive ways of displaying similar images by either automatically creating a stop-motion image sequence, or by automatically creating a “story telling image” consisting of several images arranged so as to display a sequence of photos depicting an event. It is a technique that can easily be applied to digital photo frames, enhancing the way a user enjoys watching his photos.

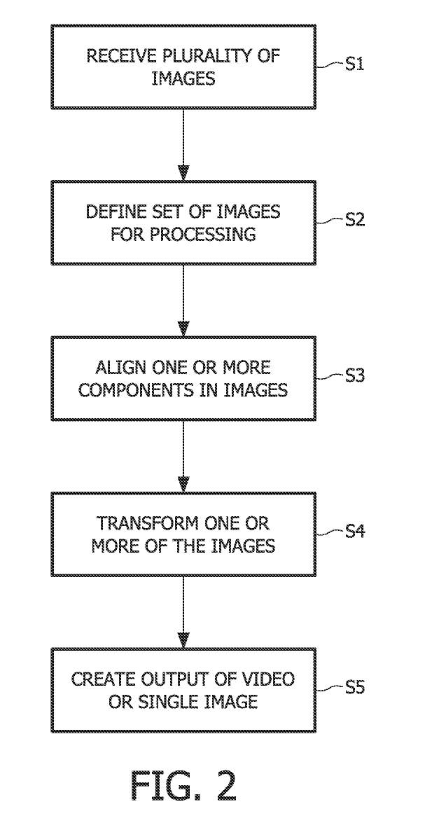

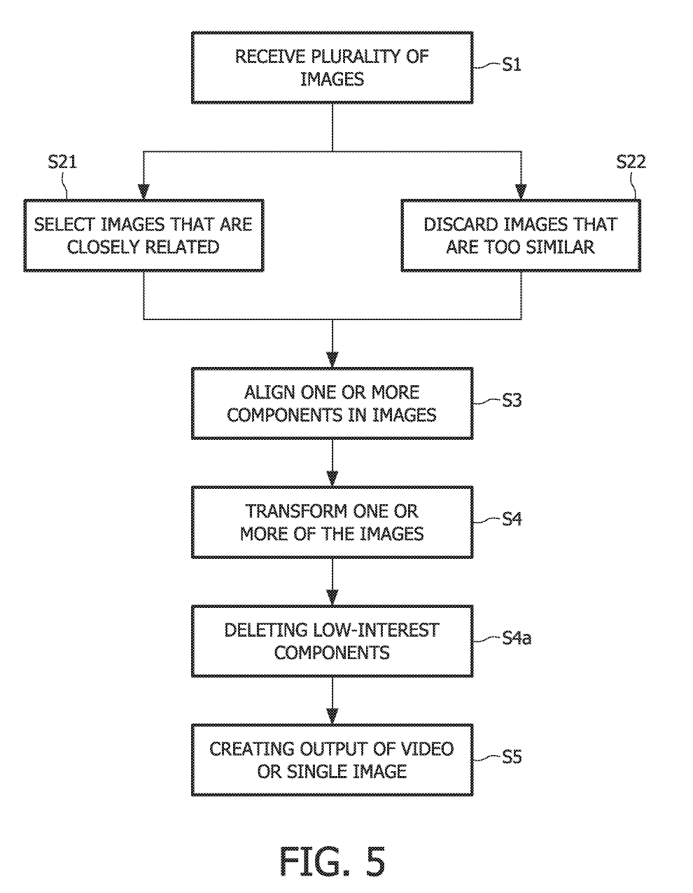

The processing carried out by the application is summarised in FIG. 2. This processing flowchart represents a basic level of processing. A number of optional improvements to this basic processing are possible, and are discussed below in more detail, with reference to FIG. 5. The process of FIG. 2 is carried out automatically by a suitable processing device. The first step in the method, step S1, is the step of receiving a plurality of images. As mentioned above, this could be as simple as the user pointing the application to the contents of folder that contains various images. The processing can also be started automatically, for example, when the user first uploads their images to the computer, or to a digital photo frame.

The next step S2 is the step of defining a set of images for processing, from the plurality of images received in step S1. In the simplest embodiment, the set will comprise all of the received images, but this will not always deliver the best results. The application can make use of clusters of images that the user would like to display. This clustering can be done, for example, by extracting low-level features (colour information, edges, and so on) and comparing the features between the images based on a distance measure for these features. If date information is available, for example through EXIF data, then this can be used to determine if two images have been taken around the same time instance. Also other clustering methods can be used, which cluster images that are visually similar. Clustering techniques based on visual appearance are known. References to such techniques can be found at http://www.visionbib.com/bibliography/match-p1494.html, comprising for example “Image Matching by Multiscale Oriented Corner Correlation”, by F. Zhao, et al, ACCV06, 2006 and at http://iris.usc.edu/Vision-Notes/bibliography/applicat805.html comprising e.g. “Picture Information Measures for Similarity Retrieval”, by S. K. Chang, et al, CVGIP, vol. 23, no. 3, 1983. For many users with digital cameras clustering will yield many clusters of images that belong to the same event, occasion or object.

The step S2 may also comprise ordering (or re-ordering) the received images 24. The default order of the images 24 may not be ideal, there may in fact be no default order, or images may be received from multiple sources which have conflicting sequences. In all of these cases, the processing will require the selected images 24 to be placed in an order. This can be based on similarity measures derived from metadata within the images 24, or again may rely on metadata stored with the images 24 to derive an order.

The application uses the clusters in order to create different ways of displaying the set of images. Assuming that there are significant differences between (some of) the images, the application executes the following steps in an automated way. At step S3 there is carried out the process step of aligning the images by aligning one or more components within the set of images. This can be done, for example, by determining feature points (such as Harris corner points or SIFT features) in the images and matching them. The feature points can be matched by translation (like panning), zoom, and even rotation. Any known image alignment techniques can be used.

Then, at step S4, the process continues by transforming one or more of the aligned images by cropping, resizing and/or rotating the image(s) to create a series of transformed images. The application is carrying out the cropping, resizing, and rotation of the images in order that the remaining parts of the images are also aligned. Colour correction could also take place during the transformation step. The alignment and transformation steps S3 and S4 are shown as sequential, with the alignment occurring first. However it is possible that these steps are occurring as a combination or with transformation occurring prior to the alignment.

Finally, at step S5, rather than showing the images in the processed cluster in the traditional way, they can be shown as a stop-motion image sequence or as a single image. This creates a very lively experience for the user when watching the photos that they took. The user can further process the output themselves, for example by selecting an effect or frame border to be used with some or all images in the sequence automatically after alignment and transformation. The display rate of the images in the image sequence and the arrangement of the images in the single image (with respect to size and placement) can be established automatically or by means of user interaction. In this manner a presentation timestamp may be generated, or a “frame rate” could be set for the all or respective images. In this manner the user can customise and/or edit the final result.

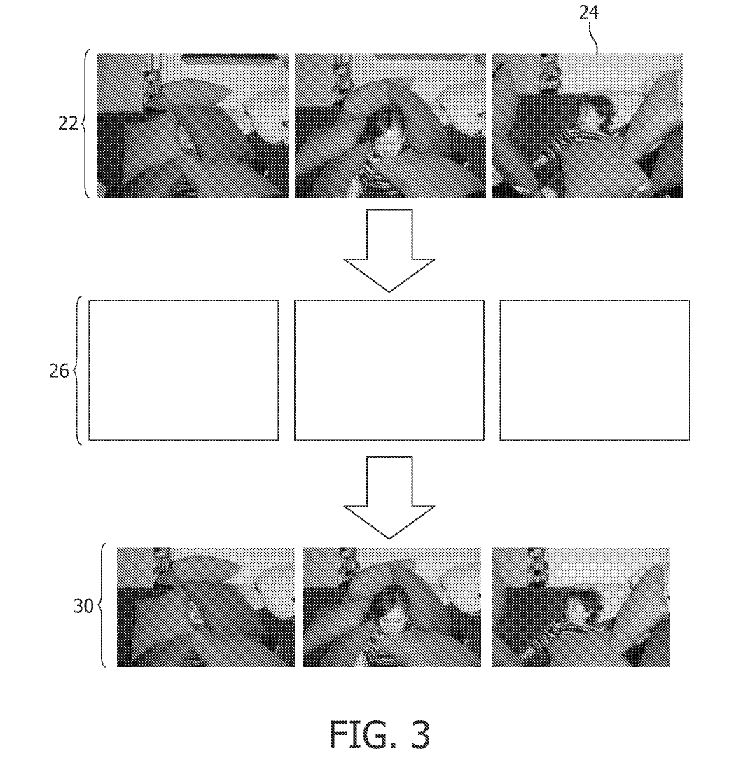

As an example, FIG. 3 shows how a plurality 22 of images 24 that are to be processed. The plurality 22 of images 24 comprises three different images, which have been supplied by the user to the application run by the processor 12, as detailed above. The user wishes these images 24 to be processed into either an image sequence or as a single image. Firstly, the processor 12 will define a set of images for which the image adaption techniques will be used. In this example, all three of the original input images 24 will be used as the set. Computing the step S2 above, based on low-level information in the three pictures, it will be seen that the three input images 24 can be considered as a cluster. Other information, such as metadata about the images 24 (such as the time which the images were captured) can be used additionally, or alternatively, in the clustering process.

The images 24 of the set of images 24 are then processed individually to produce aligned images 26. These are produced by aligning one or more components within the set of images 24. In general such an alignment is not carried out on one (small) object in the image. Alignment can be done on arbitrary points spread over the image 24 with special properties such as corner points or edges, or at a global level by minimizing the difference resulting from subtracting one image 24 from the other, after trying different alignments. Changes in alignment indicate that the camera position has moved, or the focus has changed, between the taking of these two pictures. The process step involving the alignment of the components corrects for these user changes, which are very common, when multiple images of the same situation are taken.

The aligned images 26 are then transformed into the series 30, by transforming one or more of the aligned images by cropping, resizing and/or rotating the image(s) to create the series 30 of transformed images. Applying the techniques as explained, results in the resized, cropped and aligned images 30. Next, the processor 12 can create a stop-motion image sequence by displaying the photos 30 sequentially with a very short time interval between them. The processor 12 can also save the images of the image sequence as a video sequence, if an appropriate codec is available. Intervening frames may need to be generated, to obtain a suitable frame rate, either by adding in duplicate frames, or by creating intervening frames using known interpolation techniques.

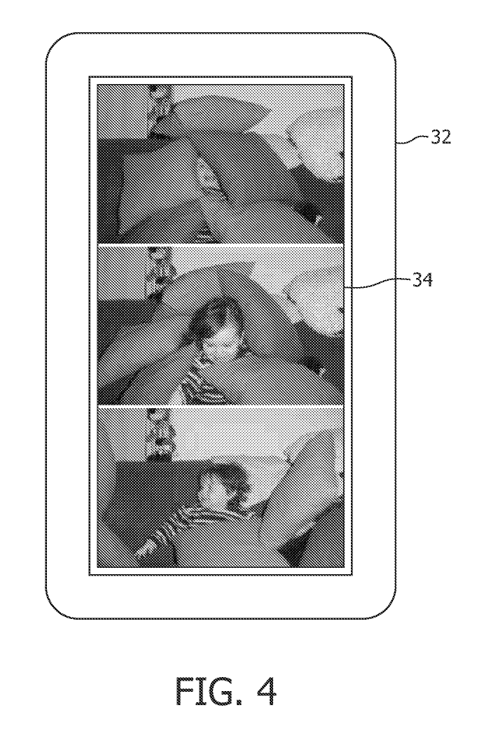

Alternatively, instead of creating a stop-motion image sequence, the processor 12 can be controlled to create one image consisting of the aligned and cropped images 24 of the defined cluster. This procedure results in one collage image that tells the story of a specific event or occasion, and can also enhance the experience of the user. For the images 24 shown in FIG. 3, the resulting collage would correspond to the digital photo frame 32 shown in FIG. 4. In this case the images 24, from the original plurality 22 of images 24, once they have been processed according to the methodology of FIG. 2, are output to the user as a single image 34 in the photo frame 32. Indeed, if the capability is present, then the final output 34 can be printed for the user.

The photo frame shown in FIG. 4 has received the final output image 34 from the processor 12 of the computer of FIG. 1. However, the processing capability of the computer and the software functionality of the application that processes the images 24 can also be provided internally within the digital photo frame 32. In this case, the images 24 that are supplied for processing can be received directly at the photo frame 32, for example by plugging in a mass storage device such as a USB key directly into the photo frame 32. The internal processor of the photo frame 32 will then acquire the images 24, process them according to the scheme of FIG. 2, and then display them as the final output 34.

The photo frame 32 can also be controlled to output an image sequence, rather than the single image 34. This can be as a stop-motion image sequence based on the images used to make up the single image 34. Metadata may be generated and provided together with the images for use in displaying such image sequences. This metadata may be embedded in the image headers, or in a separate image sequence descriptor file describing the image sequence. This metadata may encompass, but is not limited to, references to images in the sequence, and/or presentation time stamps. Alternatively an image sequence can be stored directly on the photo frame as an AVI, thereby allowing use of an existing codec available in the photo frame.

Optionally, provided that the photo frame 32 has sufficient processing resources, an image sequence descriptor file may be employed comprising metadata describing the alignment and processing steps required for obtaining the output image or output image sequence based on the original(raw) images provided. Consequently image integrity of the original images is preserved, thereby allowing new image sequences to be created without loss of information, i.e. without affecting the original images.

As the frame rate of a stop motion sequence may be substantially less than that of a conventional video sequence, the processing resource requirements of displaying a stop motion sequence may in fact allow displays having limited processing resources to use separate image sequence descriptor files referring to the original images.

Various improvements to the basic method of processing the images 24 are possible. FIG. 5 shows a flowchart similar to that of FIG. 2, but with a number of enhancements that will improve the final output to the user. These optional features can be used on their own, or in combination. Whether these features are included in the processing method can be under the control of the user, and indeed the processing can be run through with different combinations of the features employed, so that the user can look at the different possible end results and choose the combination of features as appropriate. The features can be presented to the user by the application within the graphical user interface of the application when it is run by the processing device 12.

In the embodiment of FIG. 5, the step of defining a set of images for processing, from the plurality of images, at step S21, comprises selecting one or more images 24 that are closely related according to metadata associated with the images 24. This may be metadata that is extracted from the images 24, such as low-level features like colour, or may be metadata stored with the image 24 when it is captured, or a combination of these features. The original plurality 22 of images 24 that is provided can be cut down in number by only selecting those images 24 that are considered to be closely related. In general, images captured by the camera 16 will have some sort of metadata stored with the image 24 at the same time, either according to some known standard such as EXIF, or according to a proprietary standard specific to the camera manufacturer. This metadata, which might be, for example, the time at which the image 24 was captured, can be used to select only those images 24 that fall within a specific predetermined time window.

Another optional next step, step S22, is to check that the images 24 are not too similar, in the sense that there is hardly any difference between individual pairs of images 24. This frequently happens if people just shoot a few photos of, for example a building, with the intention to have at least one good image 24 from which they can make a selection. In that case there is no reason to apply the process to the whole cluster, it is actually smarter to select only one image and use that one. The steps S21 and S22 can be run in parallel or sequentially or selectively (only one or the other being used). These implementation improvements lead to a better end result in the final output of the process.

The method of FIG. 5 also includes the optional step S4a, where, following transformation of the aligned images, there is carried out detecting of one or more low-interest components within the aligned images and then cropping the aligned images to remove the detected low-interest component(s). For example, if the processor 12 detects that specific regions of the images 24 contain hardly any changes, then the processor 12 can regard these areas as low-interest and crop the images 24 to the specific regions where the changes are the most significant. It is important that, if the processor 12 recognizes objects, then the processing should try to keep the objects as a whole. Therefore this could be used in cases where there are large amounts of background like sky or sea. For the current photo frames the image sizes are, in general, too big, so cropping will not degrade their quality.

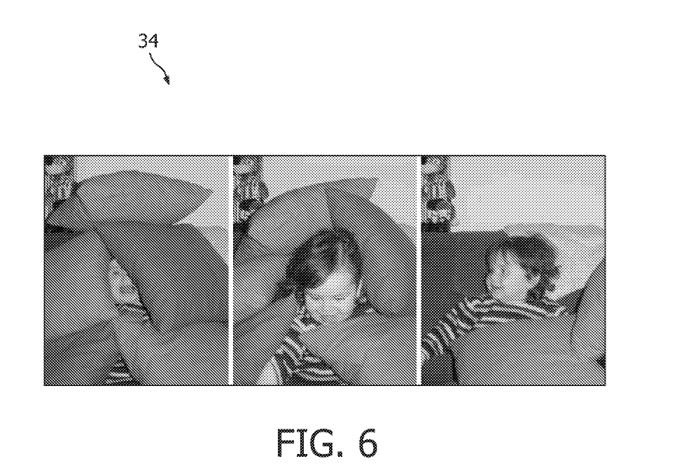

FIG. 6 shows an output 34 of the processing according to the flowchart of FIG. 5. In this case, step 4a has been used as an optional improvement in the image processing. In this example, face detection has been used to select and further crop parts of the images for creating a horizontal view. Low-interest components within the images have been removed by cropping parts of the images, in order to increase the amount of display area that is used for the parts of the images which are generally considered to be the most important. The aspect ratios of the images have been maintained, and the final output 34 has been constructed as a single image 34, rather than as a stop motion image sequence.

1. A method of processing a plurality of images comprising:
receiving a plurality of images,
defining a set of images for processing, from the plurality of images,
aligning one or more components within the set of images,
transforming one or more of the aligned images by cropping, resizing and/or rotating the image(s) to create a series of transformed images, and
creating an output comprising the series of transformed images, the output comprising either an image sequence or a single image.

2. A method according to claim 1, wherein the step of defining a set of images for processing, from the plurality of images, comprises selecting one or more images that are closely related according to metadata associated with the images.

3. A method according to claim 1, wherein the step of defining a set of images for processing, from the plurality of images, comprises discarding one or more images that fall below a similarity threshold with respect to a different image in the plurality of images.

4. A method according to claim 1, and further comprising, following transformation of the aligned images, detecting one or more low-interest components within the aligned images and cropping the aligned images to remove the detected low-interest component(s).

5. A method according to claim 1, wherein the step of defining a set of images for processing, from the plurality of images, comprises receiving a user input selecting one or more images.

6. A system for processing a plurality of images comprising:
a receiver arranged to receive a plurality of images,
a processor arranged to define a set of images for processing, from the plurality of images, to align one or more components within the set of images, and to transform one or more of the aligned images by cropping, resizing and/or rotating the image(s) to create a series of transformed images, and
a display device arranged to display an output comprising the series of transformed images, the output comprising either a stop motion video sequence or a single image.

7. A system according to claim 6, wherein the processor is arranged, when defining a set of images for processing, from the plurality of images, to select one or more images that are closely related according to metadata associated with the images.

8. A system according to claim 6, wherein the processor is arranged, when defining a set of images for processing, from the plurality of images, to discard one or more images that fall below a similarity threshold with respect to a different image in the plurality of images.

9. A system according to claim 6, wherein the processor is further arranged, following transformation of the aligned images, to detect one or more low-interest components within the aligned images and to crop the aligned images to remove the detected low-interest component(s).

10. A system according to claim 6, and further comprising a user interface arranged to receive a user input selecting one or more images, wherein the processor is arranged, when defining a set of images for processing, from the plurality of images, to employ the user selection.

11. A computer program product on a computer readable medium for processing a plurality of images, the product comprising instructions for:
receiving a plurality of images,
defining a set of images for processing, from the plurality of images,
aligning one or more components within the set of images,
transforming one or more of the aligned images by cropping, resizing and/or rotating the image(s) to create a series of transformed images, and
creating an output comprising the series of transformed images, the output comprising either a stop motion video sequence or a single image.

12. A computer program product according to claim 11, wherein the instructions for defining a set of images for processing, from the plurality of images, comprise instructions for selecting one or more images that are closely related according to metadata associated with the images.

13. A computer program product according to claim 11, wherein the instructions for defining a set of images for processing, from the plurality of images, comprise instructions for discarding one or more images that fall below a similarity threshold with respect to a different image in the plurality of images.

14. A computer program product according to claim 11, and further comprising, following transformation of the aligned images, instructions for detecting one or more low-interest components within the aligned images and cropping the aligned images to remove the detected low-interest component(s).

15. A computer program product according to claim 11, wherein the instructions for defining a set of images for processing, from the plurality of images, comprises instructions for receiving a user input selecting one or more images.
